(19) United States
(12) Patent Application Publication
(10) Pub. No.: US 2025/0161990 A1
(43) Pub. Date: May 22, 2025

(54) POWDER DISTRIBUTING DEVICE FOR PREPARING SHEET-SHAPED MAGNETS AND POWDER DISTRIBUTING METHOD THEREOF

(71) Applicant: AAC Kaitai Technologies (Ma'anshan) Co., Ltd., Ma'anshan (CN)

(72) Inventors: Mingbo Wang, Ma'anshan (CN); Huan Sun, Ma'anshan (CN); Liyong Sun, Ma'anshan (CN); Ben Li, Ma'anshan (CN)

(21) Appl. No.: 18/638,529

(22) Filed: Apr. 17, 2024

Related U.S. Application Data
(63) Continuation of application No. PCT/CN2023/133154, filed on Nov. 22, 2023.

(51) Int. Cl. B07B 1/34; B07B 1/28; B07B 1/42; B07B 1/46; B22F 3/00; H01F 41/02

(52) U.S. Cl. CPC B07B 1/343; B07B 1/286; B07B 1/42; B07B 1/4609; B22F 3/004; H01F 41/0266

(57) ABSTRACT

A powder distributing device for preparing sheet-shaped magnets and a powder distributing method thereof are provided. The powder distributing device includes a mold, a powder feeding mechanism, and a vibrating mechanism. The mold includes a mold body and a screen disposed above the mold and connected to the mold body. The screen sifts magnetic powder into at least one mold cavity of the mold body. The powder feeding mechanism feeds the magnetic powder to the screen. The vibrating mechanism is connected to the mold body The vibrating mechanism drives the mold body and the screen to vibrate together, so that the magnetic powder on the screen is evenly sifted into the mold body and filled to a predetermined density, which improves uniformity of powder distribution in the at least one mold cavity during a molding process, thereby improving performance and consistency of the sheet-shaped magnets.

### FIELD OF THE PRESENT INVENTION

The present disclosure relates to a technical field of processing of sheet magnets and in particular to a powder distributing device for preparing sheet-shaped magnets and a powder distributing method thereof.

### DESCRIPTION OF RELATED ART

NdFeB magnets, also known as neodymium magnets, have a chemical formula of Nd2Fe14B. The NdFeB magnets are artificial permanent magnets and are permanent magnets with strongest magnetic force so far. The maximum magnetic energy product (BHmax) of the NdFeB magnets is more than 10 times greater than that of ferrite magnets. In a bare magnet state, the magnetic force of the NdFeB magnets reaches about 3500 Gauss. The NdFeB magnets have characteristics of high cost performance, small size, light weight, good mechanical properties, and strong magnetic properties. Due to a high energy density of the NdFeB magnets, NdFeB permanent magnet materials are widely used in modern industry and electronic technology, and are known as the magnet king in a magnetic field. Therefore, preparation and expansion of the NdFeB magnets are a focus of continued attention in the industry.

Currently, the industry often adopts a sintering method to prepare the NdFeB permanent magnet materials, and specific steps are as follow. Specifically, an iron-based neodymium-boron alloy raw material is smelted into an alloy liquid in an inert gas. The alloy liquid is then rapidly cooled on a cooling roller through a casting mechanism and a tundish mechanism to form an alloy flake. The alloy flake absorbs hydrogen to generate internal stress and is broken into coarse powder having a size of 100 μm. The coarse powder is crushed by airflow to form fine powder. Organic solvents are added into the fine powder to improve oxidation resistance and fluidity of the fine powder to obtain NdFeB magnetic powder, which is then molded and sintered in sequence. The NdFeB magnetic powder prepared by the above sintering method has strong viscosity and poor fluidity. In a process of molding of the NdFeB magnetic powder, a weighing method or a volume method is adopted to take a certain amount of the NdFeB magnetic powder. Then the NdFeB magnetic powder is put into mold cavities having a large size. However, in a preparation process of sheet-shaped magnets or thin-walled special-shaped magnets, mold cavities having a small size are needed. Use of the mold cavities having the large size leads to large differences in a mass of filling powder (i.e., the NdFeB magnetic powder) between different mold cavities, which ultimately affects product performance and product consistency.

### SUMMARY

In order to solve defects in the prior art, the present disclosure provides a powder distributing device for preparing sheet-shaped magnets and a powder distributing method thereof, which improves uniformity of powder distribution during a molding process of the sheet-shaped magnets, thereby improving performance and consistency of finished sheet-shaped magnets.

In a first aspect, the present disclosure provides the powder distributing device for preparing the sheet-shaped magnets. The powder distributing device includes a mold, a powder feeding mechanism, and a vibrating mechanism.

The mold includes a mold body and a screen. The screen is disposed above the mold and is connected to the mold body. The screen is configured to sift magnetic powder into at least one mold cavity of the mold body.

The powder feeding mechanism is configured to feed the magnetic powder to the screen. The vibrating mechanism is connected to the mold body and is configured to drive the mold body to vibrate. The mild body vibrates to drive the screen to vibrate.

In one optional embodiment, the vibrating mechanism includes a driving piece and a cam. The driving piece, the cam, and the mold are sequentially connected in a transmission manner. The driving piece is configured to drive the cam to rotate, and the cam rotates to drive the mold to vibrate up and down.

In one optional embodiment, the vibrating mechanism further includes a mold bracket. The mold bracket includes a base, a moving table, and guide columns. The guide columns are disposed at intervals. The moving table is disposed above the base. The mold is disposed on the moving table. A lower end of each of the guide columns is connected to the base. An upper end of each of the guide columns passes through the moving table and extends in a vertical direction. The guide columns are slidably connected to the moving table. The driving piece is disposed on the base. The cam is in transmission connection with the mold through the moving table.

In one optional embodiment, the vibrating mechanism further includes a transmission block. The transmission block is disposed on the cam. An upper end of the transmission block is connected to the moving table. A lower end of the transmission block abuts against a peripheral surface of the cam. The cam rotates to drive the transmission block to move up and down with the mold.

In one optional embodiment, a damping pad is disposed between the moving table and the driving piece. An upper end of the damping pad is connected to the moving table. A lower end of the damping pad is connected to the driving piece. Optionally, an eccentric wheel driven block is disposed below the moving table. The cam is in transmission connection with the eccentric wheel driven block. The eccentric wheel driven block is connected to the moving table.

In one optional embodiment, the vibrating mechanism further includes a pressing fixing assembly. The pressing fixing assembly includes a pressing plate and air cylinders. The pressing plate is disposed above the mold and is configured to press and fix the mold on the moving table. The air cylinders are disposed on the mold bracket. A driving end of each of the air cylinders is connected to the pressing plate to drive the pressing plate to move up and down.

In one optional embodiment, a vibration frequency of the vibrating mechanism is 1-100 Hz.

Optionally, mesh holes are defined on the screen. Each of the mesh holes is in a rectangular shape. Each of the mesh holes has a length of 4-20 mm and a width of 1-7 mm.

Optionally, mold cavities are defined in the mold body. A shape of each of the mold cavities is selected from a cuboid, a cube, a cylinder, a circular ring body and an irregular shape.

In one optional embodiment, the powder feeding mechanism includes a powder supplying tank, a first weighing hopper, a second weighing hopper, and a controller.

A first switch valve is disposed on an outlet defined on a lower end of the powder supplying tank. The first switch valve is configured to control opening and closing of the outlet defined on the lower end of the powder supplying tank. The first weighing hopper is disposed below the powder supplying tank. An inlet defined on an upper end of the first weighing hopper is connected to the outlet defined on the lower end of the powder supplying tank. A first weighing sensor is disposed on the first weighing hopper. The first weighing sensor is electrically connected to the first weighing hopper.

An inlet defined on an upper end of the second weighing hopper is connected to an outlet defined on a lower end of the first weighing hopper. An outlet defined on a lower end of the second weighing hopper is located above the screen to feed the magnetic powder to the screen. A second switch valve is disposed on the lower end of the second weighing hopper to control opening and closing of the outlet defined on the lower end of the second weighing hopper. A second weighing sensor is disposed on the second weighing hopper. The second weighing sensor is electrically connected to the second weighing hopper.

An input end of the controller is electrically connected to the first weighing sensor. An output end of the controller is electrically connected to the first switch valve. The input end of the controller is electrically connected to the second weighing sensor. The output end of the controller is electrically connected to the second switch valve. The controller controls opening and closing of the first switch valve through information output by the first weighing sensor, and the controller controls opening and closing of the second switch valve through information output by the second weighing sensor.

In one optional embodiment, mold cavities are defined in the mold body. The mold cavities are sequentially disposed in a first horizontal direction. The second weighing hopper is movable back and forth in the first horizontal direction.

Optionally, a disperser is disposed in an outlet of the second weighing hopper. The dispenser is configured to disperse the magnetic powder and then feed the magnetic powder to the screen.

In a second aspect, the present disclosure provides a powder distributing method of the powder distributing device mentioned above. The powder distributing method includes steps:
pouring the magnetic powder into the screen by the powder feeding mechanism;
starting the vibrating mechanism, enabling the vibrating mechanism to drive the mold body and the screen to vibrate together, so that the screen sifts the magnetic powder into the at least one mold cavity of the mold body until a density of the magnetic powder in the at least one mold cavity of the mold body reaches a predetermined density; and
scraping or flattening a surface of the magnetic powder in the at least one mold cavity of the mold body.

In the present disclosure, the vibrating mechanism drives the mold body and the screen to vibrate together, so that the magnetic powder on a mesh body of the screen is evenly sifted into the mold body and filled to a predetermined density, which improves uniformity of powder distribution in the at least one mold cavity during a molding process, thereby improving performance and consistency of the finished sheet-shaped magnets. In the present disclosure, driven by the vibrating mechanism, amplitudes and vibration frequencies of areas of the screen are the same, which makes an amount of the magnetic powder sifted from each of the areas of the screen basically the same. That is, an amount of the magnetic powder filled in each of areas of the at least one mold cavity of the mold body is basically the same, which avoids uneven distribution of the magnetic powder sifted by the screen in each of the areas of the mold body. In addition, driven by the vibrating mechanism, amplitudes and vibration frequencies of the areas of the mold body are also the same, which makes densities of the magnetic powder filled in the areas of the at least one mold cavity of the mold body same and avoids local molding density being too high or too low. Furthermore, the mold body and the screen vibrate together in a transmission manner, which simplifies an overall structure of the powder distributing device and saves device costs.

### BRIEF DESCRIPTION OF THE DRAWINGS

The present disclosure is further described below in conjunction with the accompanying drawings and examples.

FIG. 1 is a schematic diagram of a powder distributing device according to one embodiment of the present disclosure.

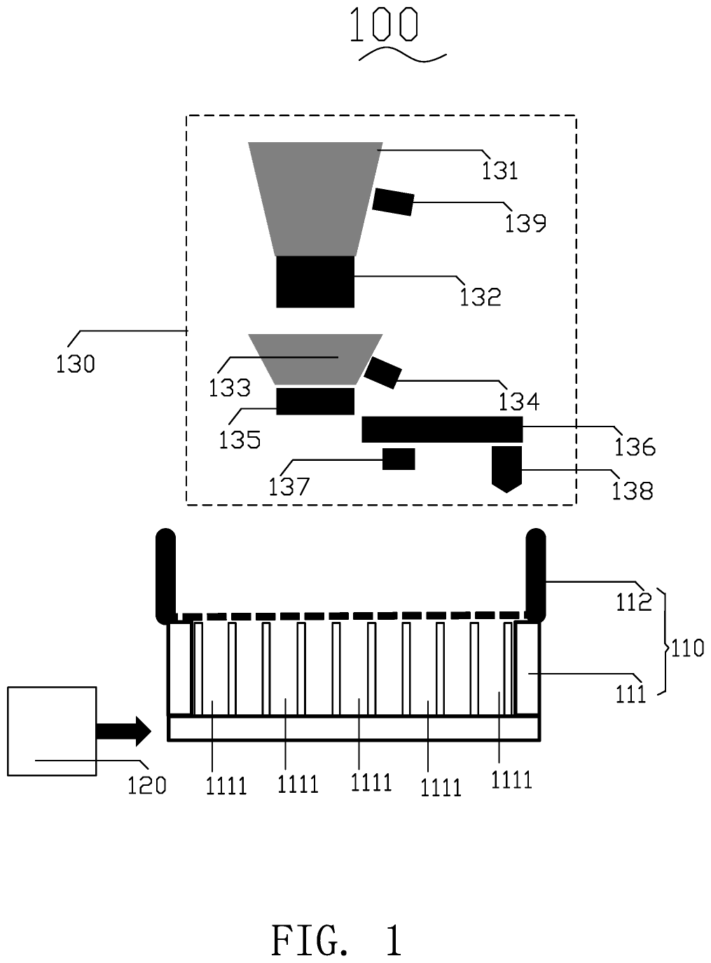

FIG. 2 is a schematic diagram of a vibrating mechanism shown in FIG. 1.

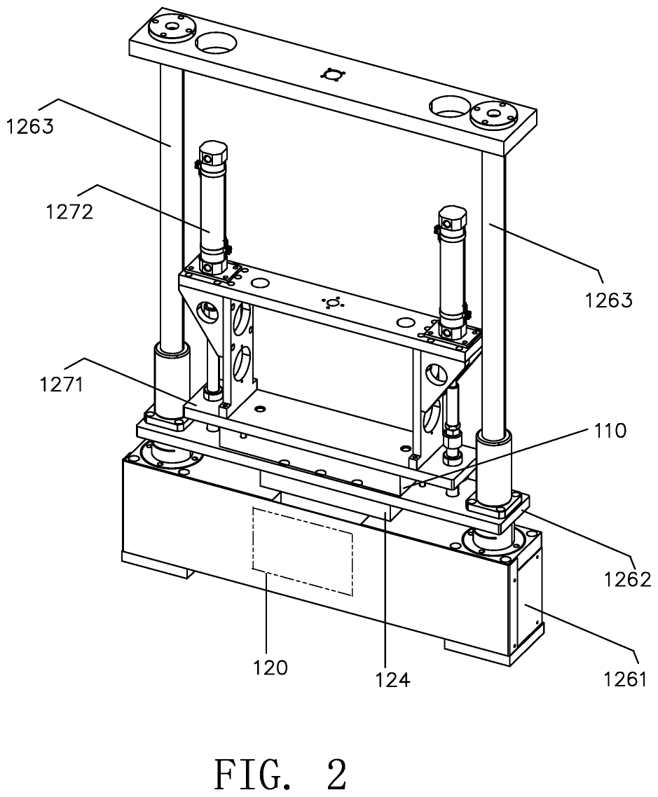

FIG. 3 is a front schematic diagram of the vibrating mechanism shown in FIG. 2.

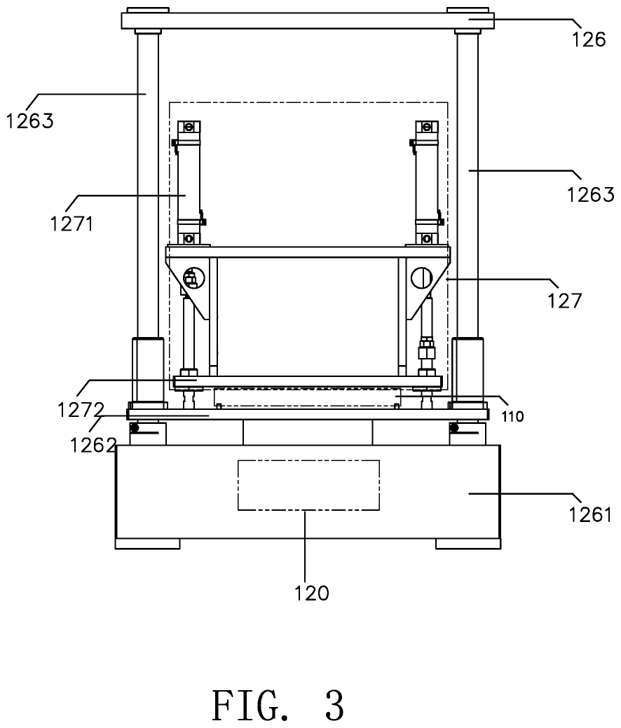

FIG. 4 is a schematic diagram of the vibrating mechanism according to another embodiment of the present disclosure.

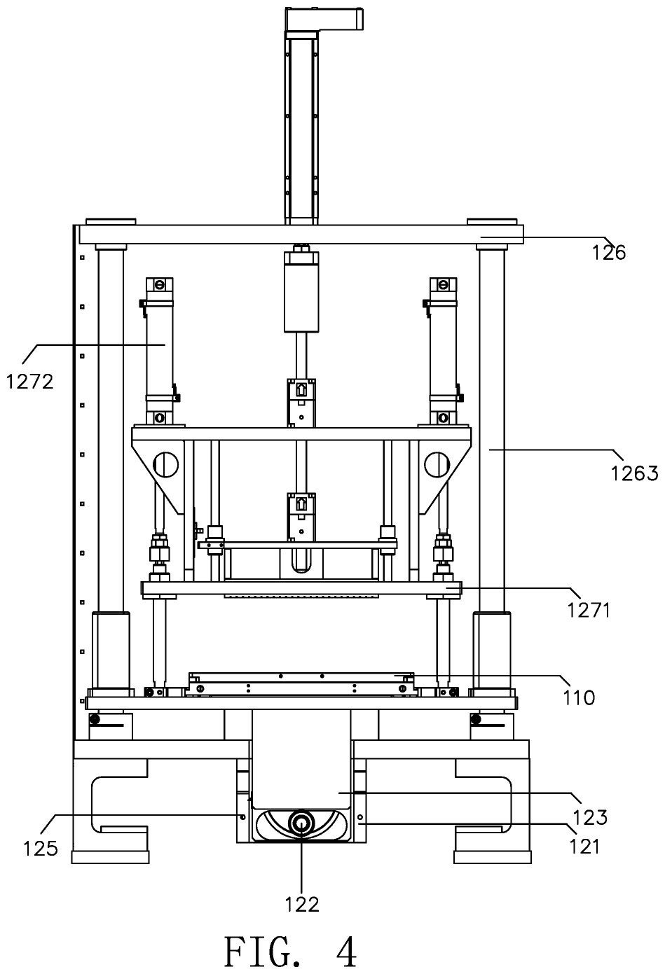

In the drawing:

| Reference | | Reference | |
|---|---|---|---|
| number | Name | number | Name |
| 100 | Powder distributing | 110 | Mold |
| | device | | |
| 111 | Mold body | 1111 | Mold cavity |
| 112 | Screen | 120 | Vibrating mechanism |
| 121 | Driving piece | 122 | cam |
| 123 | Transmission block | 124 | Damping pad |
| 125 | Eccentric wheel | 126 | Mold bracket |
| | driven block | | |
| 1261 | Base | 1262 | Moving table |
| 1263 | Guide column | 127 | Pressing fixing |
| | | | assembly |
| 1271 | Pressing plate | 1272 | Air cylinder |
| 130 | powder feeding | 131 | Powder supplying |
| | mechanism | | tank |
| 132 | First switch valve | 133 | First weighing |
| | | | hopper |
| 134 | First weighing | 135 | Vibrating platform |
| | sensor | | |
| 136 | Second weighing | 137 | Second weighing |
| | hopper | | sensor |
| 138 | Second switch valve | 139 | Knocking cylinder |

### DETAILED DESCRIPTION OF THE EXEMPLARY EMBODIMENTS

In order to better understand technical solutions of the present disclosure, embodiments of the present disclosure are described in detail below with reference to accompanying drawings.

It is noted that the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

The terminology used in the present disclosure is for a purpose of describing particular embodiments only and does not limit the present disclosure. As used in the present disclosure, singular forms such as “a kind of,” “said”, and “the” are intended to include the plural forms as well, unless the context clearly dictates otherwise.

It should be understood that the term “and/or” depicts relationship between associated objects and there are three relationships thereon. For example, A and/or B may indicate A exists alone, A and B exist at the same time, and B exists alone. The character “/” generally indicates that the associated object is alternative.

The present disclosure provides a powder distributing device 100 for preparing sheet-shaped magnets. The powder distributing device 100 includes a mold 110, a powder feeding mechanism 130, and a vibrating mechanism 120. The mold includes a mold body 111 and a screen 112. The screen 112 is disposed above the mold 110 and is connected to the mold body 111. The screen 112 is configured to sift magnetic powder into at least one mold cavity 1111 of the mold body 111. The powder feeding mechanism 130 is configured to feed the magnetic powder to the screen 112. The vibrating mechanism 120 is connected to the mold body 111 and is configured to drive the mold body 111 to vibrate. The mild body vibrates to drive the screen 112 to vibrate. The vibrating mechanism 120 may be a piston vibrator, a pneumatic hammer vibrator, or other universal mechanical vibrator.

In the present disclosure, the vibrating mechanism 120 drives the mold body 111 and the screen 112 to vibrate together, so that the magnetic powder on a mesh body of the screen 112 is evenly sifted into the mold body 111 and filled to a predetermined density, which improves uniformity of powder distribution in the at least one mold cavity 1111 during a molding process, thereby improving performance and consistency of the finished sheet-shaped magnets. In the present disclosure, driven by the vibrating mechanism 120, amplitudes and vibration frequencies of areas of the screen 112 are the same, which makes an amount of the magnetic powder sifted from each of the areas of the screen 112 basically the same. That is, an amount of the magnetic powder filled in each of areas of the at least one mold cavity 1111 of the mold body 111 is basically the same, which avoids uneven distribution of the magnetic powder sifted by the screen 112 in each of the areas of the mold body 111. In addition, driven by the vibrating mechanism 120, amplitudes and vibration frequencies of the areas of the mold body 111 are also the same, which makes densities of the magnetic powder filled in the areas of the at least one mold cavity 1111 of the mold body 111 same and avoids local molding density being too high or too low. Furthermore, the mold body 111 and the screen 112 vibrate together in a transmission manner, which simplifies an overall structure of the powder distributing device and saves device costs.

In one optional embodiment, a vibration frequency of the vibrating mechanism 120 is 1-100 Hz. That is, the vibration frequency of the vibrating mechanism 120 is 1 Hz, 20 Hz, 40 Hz, 60 Hz, 80 Hz, 100 Hz or any value between 1-100 Hz. Within the vibration frequency range, the screen 112 is allowed to stably and uniformly sift the magnetic powder into the at least one mold cavity 1111 of the mold body 111.

The screen 112 includes a mesh body and a mesh frame surrounding the mesh body. Mesh holes are defined on the mesh body of the screen 112. Each of the mesh holes of the mesh body may be in a rectangular shape, a circular shape, an elliptical shape, a triangular shape, or other polygonal shape, which is not limited thereto. In one specific embodiment, each of the mesh holes is in the rectangular shape or a square shape. Each of the mesh holes has a length of 4-20 mm and a width of 1-7 mm. Specifically, the length of each of the mesh holes is 4 mm, 10 mm, 15 mm, 20 mm or any value between 4-20 mm. Similarly, the width of each of the mesh holes is 1 mm, 3 mm, 5 mm, 7 mm or any value between 1-7 mm. Optionally, each of the mesh holes of the mesh body is a rectangular mesh hole with a length*width of 9 mm*4 mm. Of course, those skilled in the art are able to select the mesh holes of appropriate sizes and shapes according to a size and agglomeration of the magnetic powder and a size of the at least one mold cavity 1111 of the mold body 111, which is not particularly limited thereto.

There may be one or more mold cavities defined in the mold body 111. In one embodiment, the mold cavities 1111 are defined in the mold body 111 along a length direction of the mold body 111. A shape of each of the mold cavities 1111 is selected from a cuboid, a cube, a cylinder, a circular ring body, and an irregular shape. It should be noted that different mold cavities 1111 may have same or different shapes. Those skilled in the art are able to design a specific shape of the mold cavities 1111 according to actual needs, which not specifically limited thereto.

In one optional embodiment, the vibrating mechanism 120 includes a driving piece 121 and a cam 122. The driving piece 121, the cam 122, and the mold are sequentially connected in a transmission manner. The driving piece 121 is configured to drive the cam 122 to rotate, and the cam 122 rotates to drive the mold to vibrate up and down. Specifically, the driving piece 121 may be a motor or other rotational driving piece 121. A peripheral surface of the cam 122 is curved or a curved groove is defined on the peripheral surface of the cam 122. In one specific embodiment, the cam 122 includes concave portions and convex portions. The concave portions and the convex portions are alternately disposed along a circumferential direction of the cam 122. When the driving piece 121 drives the cam 122 to rotate, one of the convex portions located on an upper end of the cam 122 that abuts against the mold body 111 gradually rotates to separate from the mold body and an adjacent concave portion gradually rotates to abut against the mold body 111, the mold body 111 and the screen 112 move down as the cam 122 rotates. Similarly, when one of the concave portion located on the upper end of the cam 122 that abuts against the mold body 111 gradually rotates to separate from the mold body and an adjacent convex portion gradually rotates to abut against the mold body 111, the mold body 111 and the screen mesh 112 move up as the cam 122 rotates. Therefore, when the driving piece 121 drives the cam 122 to rotate, the mold body 111 and the screen 112 alternately move up and down. Since a moving-up distance and a moving-down distance are short, a switching time thereof is short, so that the mold body 111 and the screen 112 finally exhibit a vibrating state.

In one optional embodiment, the vibrating mechanism 120 further includes a mold bracket 126. The mold bracket 126 includes a base 1261, a moving table 1262, and guide columns 1263. The guide columns 1263 are disposed at intervals. The moving table 1262 is disposed above the base 1261. The mold is disposed on the moving table 1262. A lower end of each of the guide columns 1263 is connected to the base 1261. An upper end of each of the guide columns 1263 passes through the moving table 1262 and extends in a vertical direction. The guide columns 1263 are slidably connected to the moving table 1262. The driving piece 121 is disposed on the base 1261. The cam 122 is in transmission connection with the mold through the moving table 1262.

Furthermore, in one specific embodiment, two guide columns are provided.

The lower ends of the two guide columns 1263 are respectively fixedly connected to a left end and a right end of the base 1261. The driving piece 121 is fixedly disposed on the base 1261. The cam 122 is disposed on a front end of the driving piece 121. A left end and a right end of the moving table 1262 are slidably sleeved on the two guide columns 1263 respectively. The peripheral surface of the upper end of the cam 122 is movably connected to the moving table 1262. When the driving piece 121 drives the cam 122 to rotate, the moving table 1262 moves up and down along the guide columns 1263, thereby driving the mold body 111 and the screen 112 to vibrate up and down. In the specific embodiment, the mold body 111 and the screen 112 move up and down along the guide columns 1263 together with the moving table 1262, which avoids a problem of a deflection of a moving direction of the mold body 111 and the screen 112, thus avoiding unstable vibration amplitudes or unstable vibration frequencies of the mold body 111 and the screen 112.

In another specific embodiment, In order to facilitate a transmission connection between the cam 122 and the moving table 1262, the vibrating mechanism 120 further includes a transmission block 123. The transmission block 123 is disposed on the cam 122. An upper end of the transmission block 123 is connected to the moving table 1262. A lower end of the transmission block 123 abuts against a peripheral surface of the cam 122. The cam 122 rotates to drive the transmission block 123 to move up and down with the mold.

Furthermore, in order to avoid or reduce an upward bounce of the moving table 1262 caused by falling and colliding with the driving piece 121 disposed below the moving table 1262, In one optional embodiment, a damping pad 124 is disposed between the moving table 1262 and the driving piece 121. An upper end of the damping pad 124 is connected to the moving table 1262. A lower end of the damping pad 124 is connected to the driving piece 121. Optionally, an eccentric wheel driven block 125 is disposed below the moving table 1262. A peripheral surface of the eccentric wheel driven block 125 contacts a lower side of the moving table 1262.

In one specific embodiment, an upper end of the eccentric wheel driven block 125 is connected to a lower end of the moving table 1262 through the damping pad 124. A hole is defined on a lower end of the eccentric wheel driven block 125. A first end of the cam 122 is connected to the driving piece 121. A second end of the cam 122 passes through the hole and contacts the lower end of the transmission block 123. A portion of the peripheral surface of the cam 122 contacts an inner wall of a lower end of the hole. During a descending process of the moving table 1262, the damping pad 124 and the eccentric wheel driven block 125 together reduce the upward bounce of the moving table 1262 caused by falling and colliding with the driving piece 121 disposed below the moving table 1262.

In one optional embodiment, the vibrating mechanism 120 further includes a pressing fixing assembly 127. The pressing fixing assembly 127 includes a pressing plate 1271 and air cylinders 1272. The pressing plate 1271 is disposed above the mold and is configured to press and fix the mold on the moving table 1262. The air cylinders 1272 are disposed on the mold bracket 126. A driving end of each of the air cylinders 1272 is connected to the pressing plate 1271 to drive the pressing plate 1271 to move up and down. Specifically, the air cylinders 1272 are fixedly disposed above the mold 110. An end of a push rod of each of the air cylinders 1272 is fixedly connected to the pressure plate 1271. When the push rod of each of the air cylinders 1272 extends downward, the pressing plate 1271 moves toward the mold 110 until the mold 110 is pressed on the moving table 1262. When the push rod of each of the air cylinders 1272 retracts upward, the pressing plate 1271 moves upward, so that the mold 110 is allowed to be taken down from the moving table 1262. When the driving piece 121 drives the cam 122 to rotate, the pressing fixing assembly 127 moves up and down together with the moving table 1262 and the mold 110.

In one optional embodiment, the powder feeding mechanism 130 includes a powder supplying tank 131, a first weighing hopper 133, a second weighing hopper 136, and a controller. A first switch valve 132 is disposed on an outlet defined on a lower end of the powder supplying tank 131. The first switch valve 132 is configured to control opening and closing of the outlet defined on the lower end of the powder supplying tank 131. The first weighing hopper 133 is disposed below the powder supplying tank 131. An inlet defined on an upper end of the first weighing hopper 133 is connected to the outlet defined on the lower end of the powder supplying tank 131. A first weighing sensor 134 is disposed on the first weighing hopper 133. The first weighing sensor 134 is electrically connected to the first weighing hopper 133. An inlet defined on an upper end of the second weighing hopper 136 is connected to an outlet defined on a lower end of the first weighing hopper 133. An outlet defined on a lower end of the second weighing hopper 136 is located above the screen 112 to feed the magnetic powder to the screen 112. A second switch valve 138 is disposed on the lower end of the second weighing hopper 136 to control opening and closing of the outlet defined on the lower end of the second weighing hopper 136. A second weighing sensor 137 is disposed on the second weighing hopper 136. The second weighing sensor 137 is electrically connected to the second weighing hopper 136.

An input end of the controller is electrically connected to the first weighing sensor 134. An output end of the controller is electrically connected to the first switch valve 132. The input end of the controller is electrically connected to the second weighing sensor 137. The output end of the controller is electrically connected to the second switch valve 138. The controller controls opening and closing of the first switch valve 132 through information output by the first weighing sensor 134, and the controller controls opening and closing of the second switch valve 138 through information output by the second weighing sensor 137. The first switch valve 132 and the second switch valve 138 may be pneumatic valves, solenoid valves and other valves, which are not particularly limited thereto.

In detail, powder inlet is defined on an upper end of the powder supplying tank 131. An outer side wall of the powder supplying tank 131 is connected to a knocking cylinder 139. The knocking cylinder 139 is configured to knock the powder supplying tank 131, so that the magnetic powder in the powder supplying tank 131 is sifted into the first weighing hopper 133. A vibrating platform 135 is disposed in the lower end of the first weighing hopper 133. The magnetic powder in the first weighing hopper 133 is vibrated to fall into the second weighing hopper 136 through the vibrating platform 135. During operation, an operator feeds the magnetic powder into the powder supplying tank 131 from the powder inlet and opens the first switch valve 132, so the magnetic powder falls into the first weighing hopper 133 from the outlet defined on the lower end of the powder supplying tank 131. When the first weighing sensor 134 senses that a weight of the magnetic powder in the first weighing hopper 133 reaches a first predetermined weight, the controller controls the first switch valve 132 to close and controls the vibrating platform 135 to start, so that the magnetic powder in the first weighing hopper 133 is sifted into the second weighing hopper 136. When a weight of the magnetic powder in the second weighing hopper 136 sensed by the second weighing sensor 137 reaches a second predetermined weight, the controller controls the vibrating platform 135 to close, and the magnetic powder in the first weighing hopper 133 stops falling into the second weighing hopper 136. Then, the controller controls the second switch valve 138 to open, and the second weighing hopper 136 feeds the magnetic powder to the screen 112. When the second weighing sensor 137 senses that a weight of the magnetic powder fed to the screen 112 through the second weighing hopper 136 reaches a third predetermined weight, the controller controls the second switch valve 138 to close.

In the embodiment, the outlet defined on the lower end of the second weighing hopper 136 is a hollow structure. Optionally, a disperser is disposed in the outlet of the second weighing hopper 136. The dispenser is configured to disperse the magnetic powder and then feed the magnetic powder to the screen 112. Specifically, the disperser may be a screw, a paddle, or other structure that is able to scatter the magnetic powder.

The mold cavities 1111 of the mold body 111 are sequentially disposed in a first horizontal direction. In order to improve powder distribution uniformity of the powder feeding mechanism 130, the second weighing hopper 136 is movable back and forth in the first horizontal direction. During operation, the second weighing hopper 136 uniformly feeds the magnetic powder to each of the areas of the screen 112 by moving back and forth in the first horizontal direction, thereby improving the distribution uniformity of the magnetic power in the mold cavities 1111 by the screen 112.

The present disclosure provides a powder distributing method of the powder distributing device 100 mentioned above. The powder distributing method includes steps as follow.

The magnetic powder is poured into the screen 112 by the powder feeding mechanism 130. That is, the amount of the magnetic powder poured into the screen 112 by the powder feeding mechanism 130 is not less than the amount of the magnetic powder predetermined to be filled in the mold body 111, so as to improve the uniformity of the magnetic powder as much as possible. Especially for the mold body 111 having the mold cavities 1111, powder mass differences between the mold cavities 1111 are reduced.

The vibrating mechanism 120 is started, and the vibrating mechanism 120 drives the mold body 111 and the screen 112 to vibrate together, so that the screen 112 sifts the magnetic powder into the mold cavities 1111 of the mold body 111 until a density of the magnetic powder in the at least one mold cavity 1111 of the mold body 111 reaches a predetermined density.

A surface of the magnetic powder in each of the mold cavities 1111 of the mold body 111 is scrapped or flattened.

The surface of the magnetic powder in each of the mold cavities 1111 of the mold cavity 1111 is scraped or flattened to eliminate an uneven height of the surface of the magnetic powder in each of the mold cavities 1111 of the mold body 111 caused by loose density difference of the magnetic powder stored therein, different of directions of vibration forces, value differences of the vibration force, and other reasons. Specifically, the surface of the magnetic powder in each of the mold cavities 1111 is scraped or flatten by using a scrapping plate or a scrapping bar, or the surface of the magnetic powder in each of the mold cavities 1111 is flattened by a mesh screen with a suitable size matching the mold cavities 1111.

In the embodiments of the present disclosure, the magnetic powder on the mesh body of the screen 112 is uniformly sifted into the mold body 111 through the vibrating mechanism 120 and is filled in the mold cavities 1111 to the predetermined density, so that the uniformity of the magnetic powder in the one or more mold cavities is improved during a forming process of the sheet-shaped magnets, and performance and consistency of the finished sheet-shaped magnets are improved.

In the embodiments of the present disclosure, the magnetic powder is NdFeB magnetic powder. A particle size of the magnetic powder is 1-10 um, such as 1 μm, 4 um, 8 μm, 10 um, or any value between 1-10 μm, and a granularity distribution is D90/D10≤7.

In one embodiment of the present disclosure, an auxiliary agent is mixed in the magnetic powder. The auxiliary agent includes one or a combination of methyl stearate, monochlorobenzene, tributyl borate, methyl laurate, and n-hexane. A mixing device therefor may be a mixer in the industry such as a three-dimensional mixer or a V-shaped mixer.

In the embodiment of the present disclosure, the predetermined density is 3.2-4.4 g/cm³, such as 3.2 g/cm³, 3.6 g/cm³, 3.8 g/cm³, 4 g/cm³, 4.4 g/cm³, or any value between 3.2-4.4 g/cm³.

### Performance Testing

NdFeB magnets are prepared by the powder distributing method of the present disclosure and specifications of the NdFeB magnets are as follow.

Embodiments 1-3: square magnets with a width*height*thickness of 40 mm*20 mm*9.5 mm are prepared. There are 25 mold cavities and 25 square magnets are prepared accordingly. The mass distribution of the 25 magnets is shown in Table 1 below (Range=maximum value-minimum value, fluctuation=range/mean/2):

| Item | Embodiment 1 | Embodiment 2 | Embodiment 3 |
|---|---|---|---|
| Mold cavity 1 (g) | 27.7 | 27.4 | 28.3 |
| Mold cavity 2 (g) | 28.1 | 27.6 | 28.3 |
| Mold cavity 3 (g) | 28.2 | 27.9 | 28.6 |
| Mold cavity 4 (g) | 28.2 | 27.8 | 28.9 |
| Mold cavity 5 (g) | 28.4 | 27.9 | 29.1 |
| Mold cavity 6 (g) | 28.3 | 28.1 | 29.1 |
| Mold cavity 7 (g) | 28.3 | 28.3 | 29.2 |
| Mold cavity 8 (g) | 28.3 | 28.1 | 28.9 |
| Mold cavity 9 (g) | 28.3 | 28.3 | 28.8 |
| Mold cavity 10 (g) | 28.4 | 28.6 | 28.6 |
| Mold cavity 11 (g) | 28.5 | 28.6 | 28.7 |
| Mold cavity 12 (g) | 29.0 | 28.4 | 28.8 |
| Mold cavity 13 (g) | 28.6 | 28.8 | 29.1 |
| Mold cavity 14 (g) | 29.1 | 28.8 | 29.0 |
| Mold cavity 15 (g) | 28.8 | 28.8 | 29.0 |
| Mold cavity 16 (g) | 28.7 | 28.6 | 28.8 |
| Mold cavity 17 (g) | 28.4 | 28.6 | 29.0 |
| Mold cavity 18 (g) | 28.5 | 28.7 | 28.6 |
| Mold cavity 19 (g) | 28.8 | 28.4 | 28.4 |
| Mold cavity 20 (g) | 28.7 | 28.7 | 28.6 |
| Mold cavity 21 (g) | 29.1 | 28.4 | 28.6 |
| Mold cavity 22 (g) | 28.8 | 28.6 | 28.6 |
| Mold cavity 23 (g) | 28.5 | 28.3 | 28.5 |
| Mold cavity 24 (g) | 28.5 | 28.6 | 28.3 |
| Mold cavity 25 (g) | 28.3 | 28.3 | 28.1 |
| Mean | 28.5 | 28.3 | 28.7 |
| Range | 1.39 | 1.33 | 1.05 |
| Density | 3.75 | 3.73 | 3.78 |
| Fluctuation | ±1.7% | ±2.2% | ±1.5% |

It can be seen from the above Table 1 that differences between the maximum mass and the minimum mass of the square magnets in Examples 1-3 are 1.39 g, 1.33 g, and 1.05 g respectively, and the mass fluctuations are ±1.7%, ±2.2%, and ±1.5% respectively. That is, in the same batch of the square magnets, mass fluctuations of the square magnets produced in different mold cavities are small, and the mass distribution uniformity of the magnetic powder in each of the mold cavities is high.

Embodiments 4-6: hollow ring-shaped magnets are prepared. There are 16 mold cavities in the mold body, and 16 hollow ring-shaped magnets are produced. The mass distribution of the 16 hollow ring-shaped magnets is shown in Table 2 below (Range=maximum value-minimum value, fluctuation=Range/Mean/2):

| Item | Embodiment 4 | Embodiment 5 | Embodiment 6 |
|---|---|---|---|
| Mold cavity 1 (g) | 0.857 | 0.863 | 0.862 |
| Mold cavity 2 (g) | 0.841 | 0.827 | 0.838 |
| Mold cavity 3 (g) | 0.845 | 0.820 | 0.833 |
| Mold cavity 4 (g) | 0.863 | 0.834 | 0.877 |
| Mold cavity 5 (g) | 0.830 | 0.848 | 0.871 |
| Mold cavity 6 (g) | 0.864 | 0.864 | 0.850 |
| Mold cavity 7 (g) | 0.880 | 0.860 | 0.882 |
| Mold cavity 8 (g) | 0.868 | 0.821 | 0.861 |
| Mold cavity 9 (g) | 0.843 | 0.849 | 0.851 |
| Mold cavity 10 (g) | 0.868 | 0.867 | 0.875 |
| Mold cavity 11 (g) | 0.861 | 0.869 | 0.878 |
| Mold cavity 12 (g) | 0.856 | 0.829 | 0.855 |
| Mold cavity 13 (g) | 0.866 | 0.834 | 0.846 |
| Mold cavity 14 (g) | 0.829 | 0.848 | 0.856 |
| Mold cavity 15 (g) | 0.824 | 0.824 | 0.833 |
| Mold cavity 16 (g) | 0.841 | 0.835 | 0.851 |
| Mean | 0.852 | 0.843 | 0.857 |
| Maximum value | 0.880 | 0.869 | 0.882 |
| Minimum value | 0.824 | 0.820 | 0.833 |
| Range | 0.055 | 0.049 | 0.049 |
| Mass fluctuation | ±3.2% | ±2.9% | ±2.8% |

It can be seen from the above Table 2 that differences between the maximum mass and the minimum mass of the hollow ring-shaped magnets in Examples 4-6 are 0.055 g, 0.049 g, and 0.049 g respectively, and the mass fluctuations are ±3.2%, ±2.9%, and ±2.8% respectively. That is, in the same batch of the hollow ring-shaped magnets, mass fluctuations of the hollow ring-shaped magnets produced in different mold cavities are small, and the mass distribution uniformity of the magnetic powder in each of the mold cavities is high. Compared with Embodiments 1-3, the mass fluctuations of the hollow ring-shaped magnets prepared in Embodiments 4-6 are slightly larger, mainly because the hollow ring-shaped magnets are the sheet-shaped magnets and it is more difficult to fill the magnetic powder in the mold cavities having a ring shape, which results in large mass fluctuations.

The above are only optional embodiments of the present disclosure and are not intended to limit the present disclosure. Any modifications, equivalent substitutions, and improvements made within the spirit and principles of the present disclosure shall be included in the protection scope of the present disclosure.

What is claimed is:

1. A powder distributing device for preparing sheet-shaped magnets, comprising:
a mold,
a powder feeding mechanism, and
a vibrating mechanism;
wherein the mold comprises a mold body and a screen; the screen is disposed above the mold and is connected to the mold body; the screen is configured to sift magnetic powder into at least one mold cavity of the mold body;
the powder feeding mechanism is configured to feed the magnetic powder to the screen; the vibrating mechanism is connected to the mold body and is configured to drive the mold body to vibrate, and the mild body vibrates to drive the screen to vibrate.

2. The powder distributing device according to claim 1, wherein the vibrating mechanism comprises a driving piece and a cam; the driving piece, the cam, and the mold are sequentially connected in a transmission manner; the driving piece is configured to drive the cam to rotate, and the cam rotates to drive the mold to vibrate up and down.

3. The powder distributing device according to claim 2, wherein the vibrating mechanism further comprises a mold bracket; the mold bracket comprises a base, a moving table, and guide columns; the guide columns are disposed at intervals; the moving table is disposed above the base; the mold is disposed on the moving table; a lower end of each of the guide columns is connected to the base; an upper end of each of the guide columns passes through the moving table and extends in a vertical direction; the guide columns are slidably connected to the moving table; the driving piece is disposed on the base; the cam is in transmission connection with the mold through the moving table.

4. The powder distributing device according to claim 3, wherein the vibrating mechanism further comprises a transmission block; the transmission block is disposed on the cam; an upper end of the transmission block is connected to the moving table; a lower end of the transmission block abuts against a peripheral surface of the cam; the cam rotates to drive the transmission block to move up and down with the mold.

5. The powder distributing device according to claim 4, wherein a damping pad is disposed between the moving table and the driving piece; an upper end of the damping pad is connected to the moving table; a lower end of the damping pad is connected to the driving piece; and/or
an eccentric wheel driven block is disposed below the moving table; the cam is in transmission connection with the eccentric wheel driven block; the eccentric wheel driven block is connected to the moving table.

6. The powder distributing device according to claim 3, wherein the vibrating mechanism further comprises a pressing fixing assembly; the pressing fixing assembly comprises a pressing plate and air cylinders; the pressing plate is disposed above the mold and is configured to press and fix the mold on the moving table; the air cylinders are disposed on the mold bracket; a driving end of each of the air cylinders is connected to the pressing plate to drive the pressing plate to move up and down.

7. The powder distributing device according to claim 1, wherein a vibration frequency of the vibrating mechanism is 1-100 Hz; and/or
mesh holes are defined on the screen; each of the mesh holes is in a rectangular shape; each of the mesh holes has a length of 4-20 mm and a width of 1-7 mm; and/or
mold cavities are defined in the mold body; a shape of each of the mold cavities is selected from a cuboid, a cube, a cylinder, a circular ring body and an irregular shape.

8. The powder distributing device according to claim 1, wherein the powder feeding mechanism comprises a powder supplying tank, a first weighing hopper, a second weighing hopper, and a controller;
wherein a first switch valve is disposed on an outlet defined on a lower end of the powder supplying tank; the first switch valve is configured to control opening and closing of the outlet defined on the lower end of the powder supplying tank; the first weighing hopper is disposed below the powder supplying tank; an inlet defined on an upper end of the first weighing hopper is connected to the outlet defined on the lower end of the powder supplying tank; a first weighing sensor is disposed on the first weighing hopper; the first weighing sensor is electrically connected to the first weighing hopper;
wherein an inlet defined on an upper end of the second weighing hopper is connected to an outlet defined on a lower end of the first weighing hopper; an outlet defined on a lower end of the second weighing hopper is located above the screen to feed the magnetic powder to the screen; a second switch valve is disposed on the lower end of the second weighing hopper to control opening and closing of the outlet defined on the lower end of the second weighing hopper; a second weighing sensor is disposed on the second weighing hopper; the second weighing sensor is electrically connected to the second weighing hopper;
wherein an input end of the controller is electrically connected to the first weighing sensor; an output end of the controller is electrically connected to the first switch valve; the input end of the controller is electrically connected to the second weighing sensor; the output end of the controller is electrically connected to the second switch valve; the controller controls opening and closing of the first switch valve through information output by the first weighing sensor, and the controller controls opening and closing of the second switch valve through information output by the second weighing sensor.

9. The powder distributing device according to claim 1, wherein mold cavities are defined in the mold body; the mold cavities are sequentially disposed in a first horizontal direction; the second weighing hopper is movable back and forth in the first horizontal direction; and/or
a disperser is disposed in an outlet of the second weighing hopper; the dispenser is configured to disperse the magnetic powder and then feed the magnetic powder to the screen.

10. A powder distributing method of the powder distributing device according to claim 1, comprising steps:
pouring the magnetic powder into the screen by the powder feeding mechanism;
starting the vibrating mechanism, enabling the vibrating mechanism to drive the mold body and the screen to vibrate together, so that the screen sifts the magnetic powder into the at least one mold cavity of the mold body until a density of the magnetic powder in the at least one mold cavity of the mold body reaches a predetermined density;
scraping or flattening a surface of the magnetic powder in the at least one mold cavity of the mold body.
